(19) United States
(12) Patent Application Publication
(10) Pub. No.: US 2008/0128106 A1
(43) Pub. Date: Jun. 5, 2008

(54) Combustion suppressing gas supply device for molten metal and combustion suppressing gas supply method for molten metal

(75) Inventors: Toru Kato, Aichi (JP); Takashi Suzuki, Aichi (JP); Masaki Furuta, Aichi (JP); Toru Nakamura, Aichi (JP); Hiroshi Sanui, Kai-shi (JP); Yuji Nomura, Kai-shi (JP)

Correspondence Address: MORGAN LEWIS & BOCKIUS LLP, 1111 PENNSYLVANIA AVENUE NW, WASHINGTON, DC, 20004, US

(73) Assignees: Kabushiki Kaisha Tokai Rika Denki Seisakusho; Taiyo Nippon Sanso Corporation

(21) Appl. No.: 11/984,624

(22) Filed: Nov. 20, 2007

(30) Foreign Application Priority Data
Nov. 21, 2006 (JP) 2006-314547

(51) Int. Cl. B22D 46/00; A62C 3/00

(52) U.S. Cl. 164/154.1; 169/44

(57) ABSTRACT

The invention provides a gas supply device designed to supply a combustion preventing gas (mixed gas) in which a cover gas for suppressing combustion of molten magnesium held in a melting furnace and a diluting gas for diluting the cover gas are mixed with each other, the gas supply device including a carbon monoxide concentration meter for detecting combustion of a molten metal. The gas supply device further includes a gas introduction device for supplying the combustion preventing gas to the melting furnace in case it is determined that combustion of a molten metal is present, and halts supply of the combustion preventing gas to the melting furnace in case it is determined that combustion of a molten metal is absent.

### BACKGROUND OF THE INVENTION

The present invention relates to a gas supply device and a gas supply method used when a gas (combustion suppressing gas) for suppressing combustion of a molten metal held in a melting furnace is supplied to the melting furnace.

In the related art, a metal such as a magnesium alloy as a material is melted at in a high temperature state and held in a melting furnace in the manufacturing facility of a die-cast product (metal molding) used for automobile parts or OA equipment.

Such molten magnesium is fired or burnt at a temperature above a solid phase point in a state it is exposed to air. The combustion has an adverse effect on the quality of a product as well as stable operation in the manufacturing site. Thus, a cover gas is supplied to the melting furnace that covers the surface of a molten metal so as to generate a protective film (coating) on the molten metal.

The cover gas may be a sulfur hexafluoride (SF₆) gas or some of the chlorofluorocarbon gas substitutes (such as HFC-134a). The cover gas is diluted with a diluting gas such as a carbon dioxide (CO₂) gas or dry air into a mixed gas. The mixed gas is continuously supplied to the melting furnace on a constant basis from the viewpoint of suppression of combustion.

Such a cover gas or a carbon dioxide gas is a so-called global warming gases and its usage must be minimized in the current situation where the Global Warming Potential (GWP) is high and preservation of global environment is increasingly vocal.

In line with this trend, there has been used a fluoro-ketone gas that attracts public attention for its low Global Warming Potential (GWP) (refer to JP-A-2005-171374).

The fluoro-ketone gas is currently very expensive. Continuous supply of a mixed gas including a fluoro-ketone gas to a melting furnace leads to an increase in the cunning cost of a die-cast product manufacturing facility as in the related art. Even in case the fluoro-ketone gas is used, the carbon dioxide gas is generally used as a diluting gas. It is thus important to minimize the usage of the diluting gas from the viewpoint of preservation of global environment.

### SUMMARY OF THE INVENTION

The invention has been accomplished in order to solve the problems. An object of the invention is to provide a gas supply device and a combustion suppressing gas supply method for a molten metal that saves the usage of a combustion suppressing gas while effectively suppressing combustion of a molten metal thus reducing the running cost of a manufacturing facility for metal moldings as well as contributing to preservation of global environment.

In order to achieve the object, the present invention provides the following arrangements.

(1) A combustion suppressing gas supply device, the device comprising:

a gas supply unit that supplies a mixed gas composed of a mixture of a cover gas for suppressing combustion of a molten metal held in a melting furnace and a diluting gas for diluting the cover gas to the melting furnace; and

a molten metal combustion determination unit that determines presence/absence of combustion of the molten metal by detecting combustion of the molten metal or predicting combustion of the molten metal,

wherein the gas supply unit supplies the mixed gas to the melting furnace in case presence of combustion of the molten metal is determined and halts supply of the cover gas or the mixed gas to the melting furnace in case absence of combustion of the molten metal is determined.

### (2) The device according to (1), wherein

a plurality of supply areas for the mixed gas are defined in the melting furnace,

the gas supply unit starts or halts supply of the cover gas or the mixed gas to the melting furnace in a part of the gas supply areas.

### (3) The device according to (1), wherein

the gas supply unit includes a gas concentration regulating unit that regulates the concentration of the cover gas in the mixed gas, and

the gas concentration regulating unit mixes the cover gas with the diluting gas at a predetermined concentration and supplies the mixed gas to the melting furnace in case presence of combustion of the molten metal is determined and sets the concentration of the cover gas to 0 ppm and supplies the diluting gas to the melting furnace in case absence of combustion of the molten metal is determined.

### (4) The device according to (1), wherein

the molten metal combustion determination unit includes a carbon monoxide concentration meter for detecting the combustion of the molten metal by measuring the concentration of a carbon monoxide generated during the combustion.

### (5) The device according to (1), wherein

the molten metal combustion determination unit uses a charge timing with which an ingot to be melted into the molten metal is charged into the melting furnace.

(6) A combustion suppressing gas supply method comprising:

determining presence/absence of combustion of a molten metal in a melting furnace by detecting combustion of the molten metal or predicting combustion of the molten metal;

supplying mixed gas, which is composed of a cover gas for suppressing combustion of the molten metal held in the melting furnace and a diluting gas for diluting the cover gas in case presence of combustion of the molten metal is determined; and

halting supply of the cover gas or the mixed gas to the melting furnace in case absence of combustion of the molten metal is determined.

With this configuration, in case combustion of the molten metal in the melting furnace is generated, a mixed gas is supplied to the melting furnace to suppress the combustion by the molten metal combustion determination unit and the gas supply unit. In case combustion of the molten metal is not generated, supply of a cover gas or a mixed gas is halted to save the usage of the gas. This makes it possible to reduce the total usage of a cover gas or a mixed gas while effectively suppressing combustion of a molten metal.

With this configuration, in case combustion of the molten metal is generated, a mixed gas is supplied to the melting furnace to suppress combustion in a gas supply area effective for suppression of combustion among the plurality of gas supply areas (positions) of the melting furnace by the molten metal combustion determination unit and the gas supply unit and in case combustion of the molten metal is not generated, supply of a mixed gas is halted in a gas supply area effective for suppression of the combustion.

With this configuration, in case combustion of the molten metal is generated, a cover gas is supplied to the melting furnace by the amount (concentration) necessary for suppression of combustion by way of the molten metal combustion determination unit and the gas supply unit. In case combustion of the molten metal is generated, supply of a cover gas is halted (the concentration of a cover gas in a mixed gas is set to 0 ppm).

With this configuration, it is possible to precisely detect (determine) combustion of a molten metal by using a carbon monoxide concentration meter as molten metal combustion determination unit and appropriately start or halt supply of a cover gas or a mixed gas to a melting furnace depending on the presence or absence of the combustion.

With this configuration, by using as molten metal combustion determination unit charge timing with which an ingot is charged into a melting furnace, it is possible to halt supply of a cover gas or a mixed gas in a steady state and start or halt supply of the gas with the ingot charge timing. As a result, it is possible to precisely predict (determine) combustion of a molten metal and appropriately start or halt supply of a cover gas or a mixed gas depending on the presence/absence of the combustion.

With this configuration, in case combustion of the molten metal in the melting furnace is generated, a mixed gas is supplied to the melting furnace to suppress the combustion by the molten metal combustion determining step and the gas supply step. In case combustion of the molten metal is not generated, supply of a cover gas or a mixed gas is halted to save the usage of the gas. This makes it possible to reduce the total usage of a cover gas or a mixed gas while effectively suppressing combustion of a molten metal.

With the combustion suppressing gas supply device and the combustion suppressing gas supply device according to the invention, it is possible to save the usage of a combustion suppressing gas while effectively suppressing combustion of a molten metal thus reducing the running cost of a manufacturing facility for metal moldings as well as contributing to preservation of global environment.

### BRIEF DESCRIPTION OF THE DRAWINGS

FIG. 1A is a block diagram showing a connection example of a document processor according to an embodiment of the invention.

FIG. 1B is a top view (only a lid part is shown) of the melting furnace of a hot chamber die-cast machine according to an embodiment of the invention.

FIG. 2A is a device block diagram including a gas supply device according to the first embodiment of the invention.

FIG. 2B is a device block diagram including a gas supply device according to the second embodiment of the invention.

FIG. 2C is a device block diagram including a gas supply device according to the third embodiment of the invention.

FIG. 3 is a flowchart showing the operation flow of the gas supply device according to any one of the first through third embodiments of the invention.

FIG. 4 shows a one-cycle process in the manufacturing process of a magnesium die-cast product according to any one of the first through third embodiments of the invention.

FIG. 5 is a device block diagram including a gas supply device according to the fourth embodiment of the invention.

FIG. 6 is a flowchart showing the operation flow of the gas supply device according to the fourth embodiment of the invention.

FIG. 7 shows a one-cycle process in the manufacturing process of a magnesium die-cast product according to the fourth embodiment of the invention.

FIG. 8 is a device block diagram including a gas supply device according to a variation of the invention.

FIG. 9t is a flowchart showing the operation flow of the gas supply device according to a variation of the invention.

FIG. 10 shows a one-cycle process in the manufacturing process of a magnesium die-cast product according to a variation of the invention.

### DETAILED DESCRIPTION OF PREFERRED EMBODIMENTS

The inventors have obtained the following findings through earnest experiments in a facility for manufacturing magnesium die-cast products (metal moldings) and accomplished the invention:

(1) Same as the related art, in case it is considered that combustion of molten magnesium is generated, such as in case an open/close door provided on a melting furnace for holding molten magnesium is left open and the molten metal is exposed to outside air, it is necessary to supply a mixed gas containing a cover gas to a melting furnace in order to suppress the combustion to generate a protective film on the molten magnesium (restore the broken protective film).

(2) On the other hand, in case it is considered that combustion of molten magnesium is not generated, such as in case the open/close door of the melting furnace is closed and a molten metal is shielded from outside air, the surface of the molten magnesium remains covered with a cover gas by the supply of a cover gas or a mixed gas before it is shut off even when a time period is set during which supply of the cover gas or mixed gas to the melting furnace is halted under predetermined conditions. In this case, the protective film on the surface of the molten magnesium is preserved without being substantially broken, thus offering the effect of suppressing combustion of molten magnesium.

### First Embodiment

The first embodiment of the invention will be described referring to drawings:

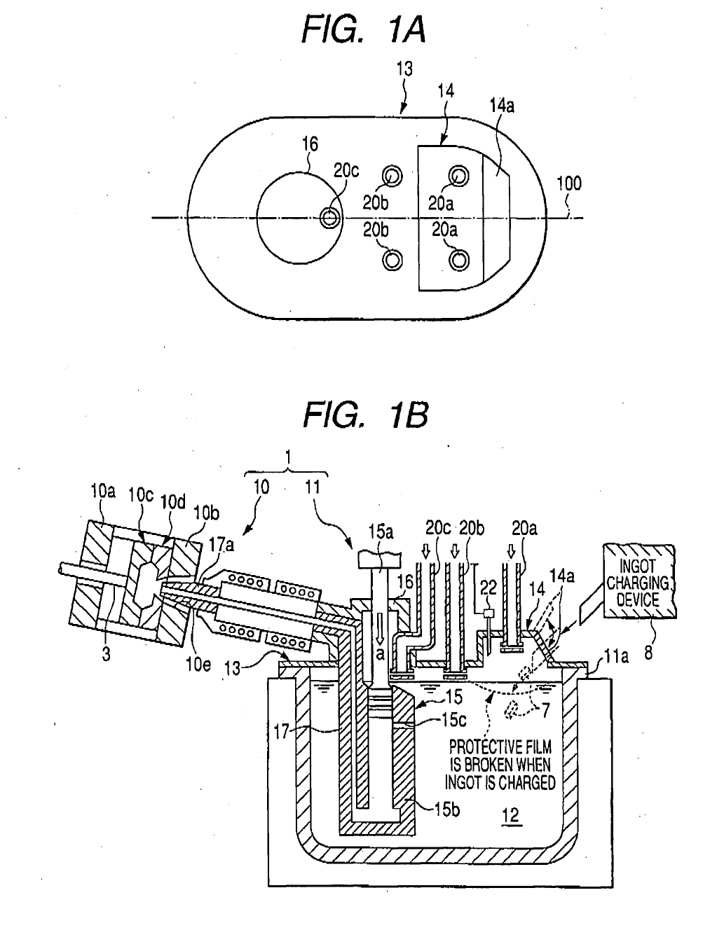

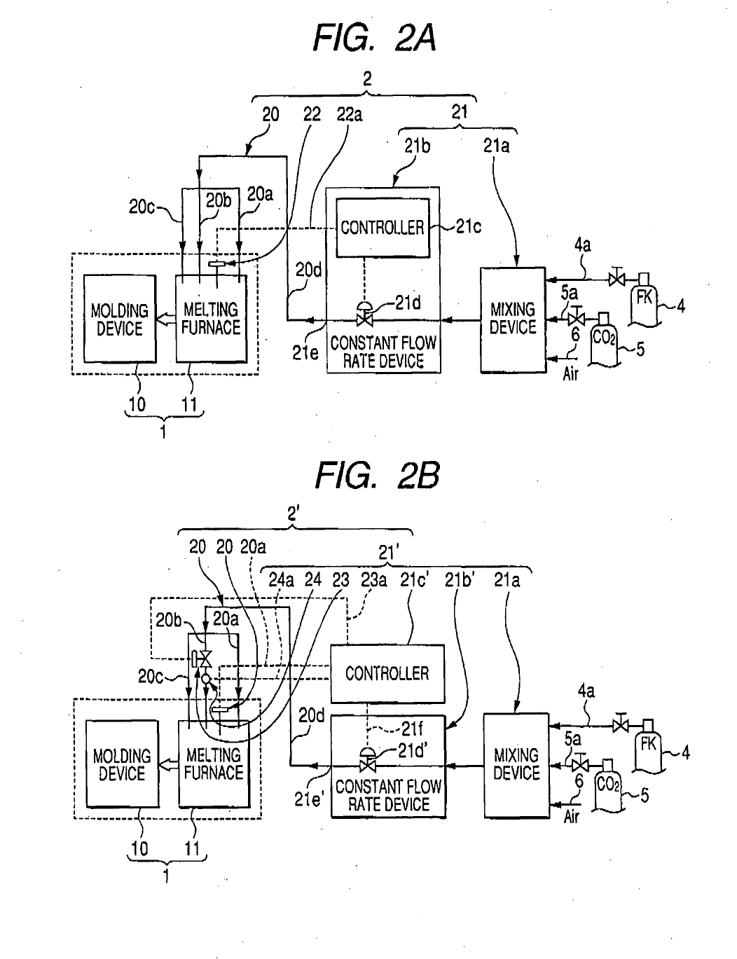

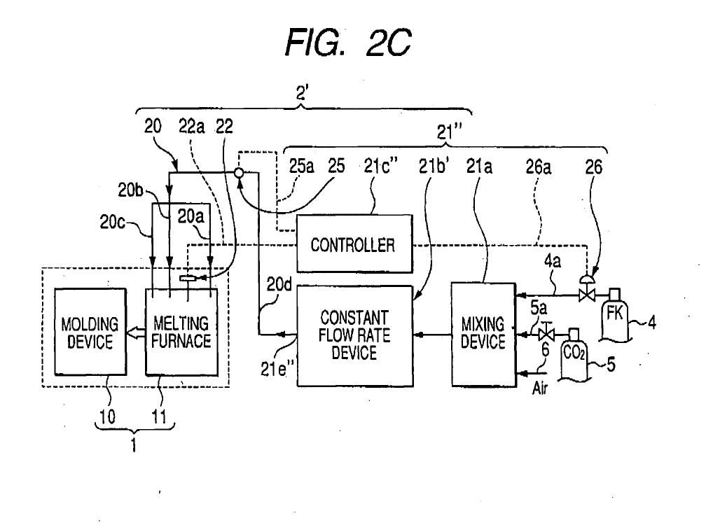

The combustion suppressing gas supply device for a molten metal (hereinafter referred to simply as the gas supply device) according to this embodiment is provided in a so-called hot-chamber die-cast machine 1 used for manufacturing a magnesium die-cast product made of a magnesium alloy and used as an automobile component shown in FIGS. 1A and 1B. The die-cast machine 1 includes a molding machine 10 for molding a die-cast product and a melting furnace 11 including a bath vessel 11a for holding a molten metal and holding molten magnesium (molten metal) 12 in a high-temperature state in the bath vessel 11a. As shown in FIG. 2A, in the melting furnace 11 is provided a gas supply device 2 according to this embodiment so as to allow a gas for suppressing combustion of molten magnesium 12 (combustion suppressing gas) to be supplied to the melting furnace 11. In this embodiment uses, as a combustion suppressing gas, a mixed gas composed of a fluoro-ketone gas diluted with a carbon dioxide gas.

Referring to FIGS. 1A and 1B, a material charging part (magnesium ingot charging part) 14 is provided on the lid part 13 arranged on the melting furnace 11. The material charging part 14 has an open/close door 14a openably mounted thereon in an open state shown by virtual lines and in a closed state shown by solid lines. With the open/close door 14a in the open state, a magnesium ingot 7 may be charged from the material charging part 14 into the melting furnace 11 by an ingot charging device 8 arranged outside the melting furnace 11. The material charging part 14 includes first pipes 20a, 20a for introducing a mixed gas into the melting furnace 11 horizontally asymmetrically with respect to the center line 100 of the melting furnace 11 and with tips thereof located above the liquid level of the molten magnesium 12. Mainly the surface of the molten magnesium 12 at a lower area of the material charging part 14 is covered with a mixed gas supplied from the gas supply device 2 of this embodiment via the pair of first pipes 20a, 20a arranged horizontally.

Referring to FIG. 1B, an injection mechanism 15 for supplying molten magnesium (molten metal) into the molding machine 10 is arranged in the bath vessel 11a of the melting furnace 11. The injection mechanism 1S includes a piston 15a and a cylinder 15b into which the piston 15a is inserted movably in vertical direction and with most potion thereof immersed in the molten magnesium 12. On the side wall of the cylinder 15b is arranged a molten metal introducing port 15c. When the piston 15a is in an upper position shown in FIG. 1B, the molten magnesium 12 in the bath vessel 11a flows from the introducing port 15c into the cylinder 15b. In the melting furnace 11, one shot (time) quantity of molten magnesium is supplied to the molding machine 10 in a single cycle of vertical movement of the piston 15a.

Referring to FIG. 1A and FIG. 1B, between the material charging part 14 of the melting furnace 11 and a piston mounting part 16 that mounts the piston 15a on the lid part 13 are arranged second pipes 20b, 20b for introducing a mixed gas into the melting furnace 11 horizontally asymmetrically with respect to the center line 100 of the melting furnace 11 and with tips thereof located slightly above the liquid level of the molten magnesium 12. Mainly the surface of the molten magnesium 12 at a lower area between the material charging part 14 and the piston mounting part 16 is covered with a mixed gas supplied from the gas supply device 2 of this embodiment to the pair of second pipes 20b, 20b arranged horizontally. As shown in FIG. 1B, the tips of the second pipes 20b, 20b are arranged in close proximity to a location of the surface of the molten magnesium 12 where the protective film is likely to be broken by the charging of a magnesium ingot 7. A cover gas is effectively supplied to restore the protective film via the pipes 20b, 20b.

Referring to FIG. 1A and FIG. 1B, on the side part of the piston mounting part 16 is arranged a third pipe 20c for introducing a mixed gas into the melting furnace 11 on to the center line 100 of the melting furnace 11 and with its tip located slightly above the liquid level of the molten magnesium 12. Mainly the surface of the molten magnesium 12 at an upper area of the cylinder 15b is covered with a mixed gas supplied from the gas supply device 2 of this embodiment via the third pipe 20c.

Referring to FIG. 1B, to the bottom of the cylinder 15b is coupled the lower end of a molten metal transport pipe 17 communicated to the molding machine 10 via the lid part 13 of the melting furnace 11 to form a path for injecting molten magnesium. When the piston 15a moves downward in the direction of an arrow a from the upper position, molten magnesium in the cylinder 15b is supplied with the movement into the molding machine 10 via the pipe 17

Referring to FIG. 1B, the molding machine 10 includes a pair of die plates 10a, 10b relatively movable in directions separated from each other. The die plates 10a, 10b respectively include molding dies 10c, 10d mounted thereon. The tip 17a of the pipe 17 reaches a molten magnesium inlet 10e formed on the molding die 10d on one side of the melting furnace 11. To the other molding die 10c is attached part of a molded article removing device 3.

As shown in FIG. 2A, the gas supply device 2 according to this embodiment includes a carbon monoxide concentration meter 22 (refer to FIG. 1B) as molten metal combustion determination unit for determining presence/absence of combustion of the molten magnesium 12 by detecting combustion of the molten magnesium 12, a gas introduction device 21 for starting or halting supply of a mixed gas to the melting furnace 11 in accordance with a carbon monoxide concentration signal sent from the carbon monoxide concentration meter 22, and a piping system 20 for supplying a mixed gas to the melting furnace 11. The piping system 20 is composed of the first pipes 20a, 20a, the second pipes 20b, 20b, the third pipe 20c described earlier and collective piping 20d coupled to these pipes.

Referring to FIG. 2A, the gas introduction device 21 includes a gas mixing device 21a for mixing several types of gases and a constant flow rate device 21b for controlling the flow rate of a mixed gas supplied from the gas mixing device 21a to a predetermined flow rate value. The gas outlet 21e of the constant flow rate device 21b is coupled to the first through third pipes 20a, 20b, 20c via the collective piping 20d.

The gas mixing device 21a includes a fluoro-ketone gas bomb 4 and a carbon dioxide gas bomb 5 respectively coupled thereto via the pipes 4a, 5a and an air introduction pipe 6 to introduce air from outside air. In the gas mixing device 21a, a fluoro-ketone gas (cover gas) for suppressing combustion of the molten magnesium 12, a carbon dioxide gas for diluting the fluoro-ketone gas and dry air (diluting gases) are mixed with each other to generate a mixed gas as a gas for suppressing combustion of the molten magnesium 12.

The fluoro-ketone gas is preferably perphloroketone with 5C to 9C. To be more precise, at least one type selected from a group composed of CF₃CF₂C(O)CF(CF₃)₂, (CF₃)₂CFC(O)CF(CF₃)₂, CF₃(CF₂)_{z}C(O)CF(CF₃)₂, CF₃(CF₂)₃C(O)CF(CF₃)₂, CF₃(CF₂)₅C(O)CF₃, CF₃CF₂C(O)CF₂CF₂CF₃, CF₃C(O)CF(CF₃)₂ and perphlorocyclohexanone may be preferably used. In this embodiment, pentaphloroethyl-heptaphloropropylketone, C₃F₇(CO)C₂F₅(CF₃CF₂C(O)CF(CF₃)₂, or CF₃CF₂C(O)CF₂CF₂CF₃, which has a low Global Warming Potential, is used.

As shown in FIG. 2A, a concentration signal from the carbon monoxide concentration meter 22 is inputted to the constant flow rate device 21b via a communication line 22a shown by broken lines. The controller 21c of the device 21b detects (determines) presence or absence of combustion by using a predetermined concentration as a reference, followed by on/off control to start/halt supply of a mixed gas. A control signal issued after the on/off control is inputted to a flow rate regulating valve 21d included in the device 21b and the flow rate regulating valve 21d supplies or shuts off a mixed gas based on the control signal.

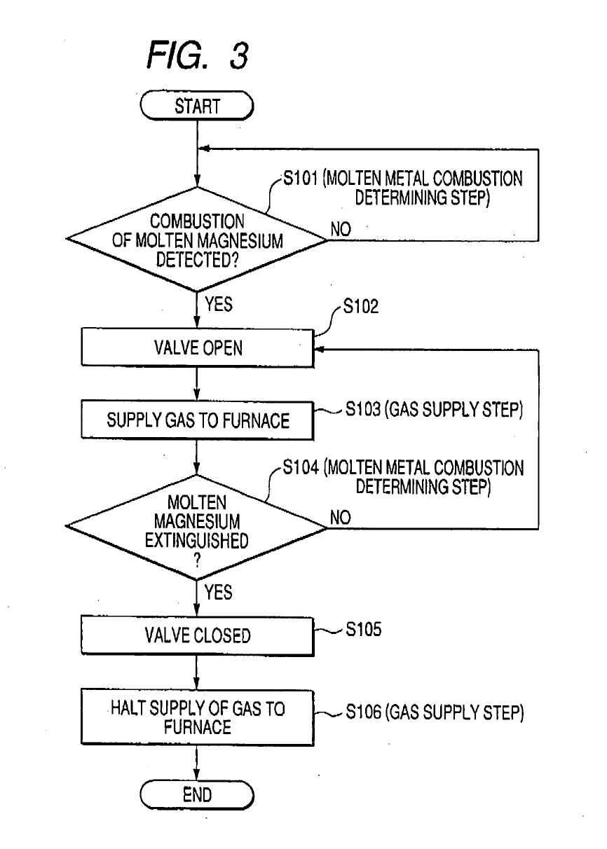

To be more precise, as shown in FIG. 3, in case it is detected (determined) that concentration of carbon monoxide in the melting furnace 11 measured by the carbon monoxide concentration meter 22 is equal to or above a predetermined concentration (15 ppm in this embodiment) and combustion of molten magnesium is present (generated) in the melting furnace 11 (YES in S101 [molten metal combustion determining step]), the flow rate regulating valve 21d (valve) of the constant flow rate device 21b is open (S102) so as to supply a mixed gas at a predetermined flow rate (11 L/minute in this embodiment). The mixed gas is then supplied to the melting furnace 11 (S103 [gas supply step]). After that, in case it is detected (determined) that concentration of carbon monoxide in the melting furnace 11 measured by the carbon monoxide concentration meter 22 is equal to or below a predetermined concentration (10 ppm in this embodiment) and combustion of molten magnesium is absent (extinguished) in the melting furnace 11 (YES in S104 [molten metal combustion determining step]), the flow rate regulating valve 21d of the constant flow rate device 21b is closed (S105) so as to halt supply of a mixed gas to the melting furnace 11 (S106 [gas supply step]).

In this embodiment, the concentration value (ppm) of carbon monoxide in the melting furnace 11 measured by the carbon monoxide concentration meter 22 is displayed on the front panel of the constant flow rate device 21b for visual check (not shown).

The following is an example of experiment to explain this embodiment in detail:

### Experiment Example

An experiment was performed using a hot chamber die-cast machine 1 shown in FIG. 1. The size of the bath vessel 11a of the melting furnace 11 is 740 mm wide, 735 mm high and 0.6 m³ in volume. The bath vessel has a maximum holding amount of 0.5 tons of molten magnesium 12. The temperature of the molten magnesium 12 in the bath vessel 11a is kept at 650° C. Checkup of presence/absence of actual combustion was made by visually observing the combustion smoke leaking from a minute gap formed between the lid part 13 and the bath vessel 11a.

As a cover gas, pentaphloroether-heptaphloropropylketone gas (hereinafter referred to simply as the FK gas) was used. A diluting gas with carbon dioxide/dry air being 50%/50% composition (volume ratio) was used. The cover gas concentration of a mixed gas composed of a cover gas and a diluting gas for diluting the cover gas was 300 ppm in steady state. The supply flow rate of the mixed gas to the melting furnace 11 was 11 L (liters)/minute.

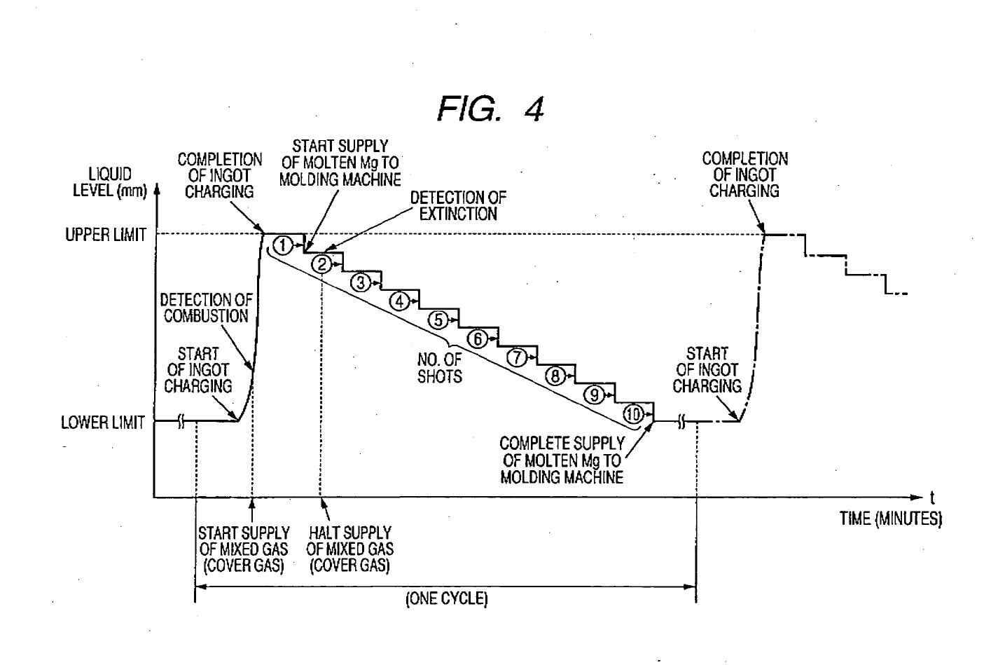

As shown in FIG. 4, this experiment was performed for one-cycle operation time (five minutes) from start of charging of a magnesium ingot into the melting furnace 11 to completion of supply of 10-shot (time) quantity of molten magnesium to the molding machine 10.

After the experiment started, a smoke from the melting furnace 11 was visually checked when a magnesium ingot was charged. The carbon monoxide concentration in the melting furnace 11 was 22 ppm.

At that time, combustion of molten magnesium 12 was detected by the carbon monoxide concentration meter 22 (YES in S101) and the flow rate regulating valve 21d of the constant flow rate device 21b was open (S12) in accordance with the flow of FIG. 3. Then, a mixed gas composed of the FK gas and a diluting gas (FK gas concentration: 300 ppm) was supplied to the melting furnace 11 at a flow rate of 11 L/minute from the gas introduction device 21 shown in FIG. 2A (S103).

After the supply for about one minute, it was determined that the smoke from the melting furnace 11 had disappeared with the carbon monoxide concentration dropped to 7 ppm. At that time, halt of combustion of the molten magnesium 12 was detected by the carbon monoxide concentration meter 22 (S104) and the flow rate regulating valve 21d of the constant flow rate device 21b was closed (S105) with supply of a mixed gas to the melting furnace 11 halted (S106).

Table 1 shows the comparison of experimental conditions and the resulting effects between a case where the gas supply device 2 of this embodiment is used and a case where a related art gas supply device is used in the manufacturing process of magnesium die-cast products for one month (total 4560 cycles).

TABLE 1

| | | | | | Converted |
|---|---|---|---|---|---|
| | Gas supply (consumption) | | | | amount of CO₂ |
| | amount (kg) | | | Gas cost | discharge |
| | FK gas | CO₂ | Dry air | (yen/month) | (kg) |
| Related art | 2.0 | 467 | 310 | 155000 | 469 |
| example | | | | | |
| This | 0.4 | 103 | 68 | 32000 | 103 |
| embodiment | | | | | |

Note)
FK gas concentration in a mixed gas: 300 ppm; Diluting gas: Carbon dioxide/dry air → 50%/50% composition (volume ratio); Supply flow rate of a mixed gas: 11 L/minute (steady state)

The gas supply device of this embodiment provides the following operation/working effects:

(1) In case combustion of the molten magnesium 12 in the melting furnace 11 is generated, a mixed gas is supplied to the melting furnace 11 to suppress the combustion by the carbon monoxide concentration meter 22 (molten metal combustion determination unit) in the melting furnace 11 of the hot chamber die-cast machine 1 and the gas introduction device 21 (gas supply unit) for starting/halting supply of a mixed gas to the melting furnace 11 based on a concentration signal from the carbon monoxide concentration meter 22. On the other hand, in case combustion is not generated, supply of the mixed gas may be halted to save the usage of the mixed gas. This makes it possible to reduce the total usage of a mixed gas while effectively suppressing combustion of molten magnesium thus reducing the running cost of a manufacturing facility for magnesium die-cast products as well as contributing to preservation of global environment.

(2) The carbon monoxide concentration meter 22 is used as molten metal combustion determination unit. This makes it possible to precisely detect combustion of the molten magnesium 12 and appropriately start or halt supply of a cover gas or a mixed gas to the melting furnace 11 depending on the presence or absence of the combustion.

The above embodiment may be modified as follows:

While the molten metal held in the melting furnace 11 is molten magnesium that easily fires or burns when exposed to air in this embodiment, the technical philosophy behind the invention is applicable to other molten metals that require supply of a cover gas to the melting furnace 11 for the same reason.

While the FK gas is used as a cover gas in this embodiment, the invention is not limited thereto. The technical philosophy behind the invention is applicable to other cover gases such as the SF₆ gas and SO₂ gas.

While a carbon monoxide concentration meter (carbon monoxide sensor) for detecting the carbon monoxide concentration in the melting furnace 11 is used as molten metal combustion determination unit in this embodiment, the molten metal combustion determination unit may be a smoke sensor for detecting a smoke generated by the combustion of the molten magnesium 12 or a furnace atmosphere temperature sensor for detecting the temperature rising at combustion of the molten magnesium 12.

While on/off control is made to start/halt supply of a mixed gas by way of the flow rate regulating valve 21d depending on the presence/absence of combustion of the molten magnesium 12 detected by using the carbon monoxide concentration meter 22 as a method for controlling start or halt of supply of a mixed gas to the melting furnace 11 in this embodiment, PID control may be made instead for changing the supply amount of a mixed gas to be supplied to the melting furnace 11 by way of the flow rate regulating valve 21d in accordance with the carbon monoxide concentration detected by the carbon monoxide concentration meter 22.

### Second Embodiment

The hot chamber die-cast machine 1 similar to that in the first embodiment is used in this embodiment. The second embodiment is the same as the first embodiment except that a gas supply device 2′ described below is used as a gas supply device. The type of the gas used is the same. Portions (members) common to those in the first embodiment are give the same or corresponding signs and the related description is omitted.

As shown in FIG. 2B, the gas supply device 2′ according to this embodiment includes a carbon monoxide concentration meter 22 (refer to FIG. 1B) as molten metal combustion determination unit for determining presence/absence of combustion of the molten magnesium 12 by detecting combustion of the molten magnesium 12, a gas introduction device 21′ for starting or halting supply of a mixed gas to the melting furnace 11 in accordance with a carbon monoxide concentration signal sent from the carbon monoxide concentration meter 22, and a piping system 20 for supplying a mixed gas to the melting furnace 11. The piping system 20 is composed of the first pipes 20a, 20a, the second pipes 20b, 20b, the third pipe 20c and collective piping 20d coupled to these pipes similar to the first embodiment. The second pipes 20b, 20b shown in FIG. 2B each includes an open/close valve 23 for passing or shutting off a mixed gas going through each second pipe 20b.

Referring to FIG. 2B, the gas introduction device 21′ includes a gas mixing device 21a for mixing several types of gases, a constant flow rate device 21b′ for controlling the flow rate of a mixed gas supplied to the melting furnace 11 from the gas mixing device 21a to a predetermined flow rate value, a controller 21c′ for controlling the flow rate of a mixed gas supplied from the device 21b′ to the melting furnace 11, open/close valves 23, 23 arranged on the second pipes 20b, 20b, and gas flowmeters 24, 24 respectively arranged on the supply side of the open/close valves 23, 23 of the second pipes 20b, 20b.

Referring to FIG. 2B, a concentration signal is inputted to the controller 21c′ from the carbon monoxide concentration meter 22 via communication lines 22a shown by broken lines and flow rate signals are respectively inputted from the gas flowmeters 24, 24 via the communication lines 22a shown by broken lines, followed by processing in the controller 21c′. After the processing, a control signal is inputted to the open/close valves 23, 23 arranged on the second pipes 20b, 20b via communication lines 23a shown by broken lines and to the flow rate regulating valve 21d′ arranged on the constant flow rate device 21b′ via communication lines 21f shown by a broken line. Each open/close valve 23 starts or halts supply of a mixed gas based on the control signal. When each open/close valve 23 is closed, the mixed gas is reduced by way of the flow rate regulating valve 21d′ by the sum value (L/minute) of flow rate measured by the gas flowmeters 24, 24 before the open/close valves 23, 23 are closed and is supplied to the melting furnace 11.

In this embodiment, with respect to the first pipes 20a, 20b and the third pipe 20c other than the second pipes 20b, 20b, a mixed gas is steadily supplied from the gas introduction device 21′ to the melting furnace 11 via the first pipes 20a, 20a and the third pipe 20c.

To be more precise, as shown in FIG. 3, in case it is detected (determined) that concentration of carbon monoxide in the melting furnace 11 measured by the carbon monoxide concentration meter 22 is equal to or above a predetermined concentration (15 ppm in this embodiment) and combustion of molten magnesium is present (generated) in the melting furnace 11 (YES in S101 [molten metal combustion determining step]), the open/close valves 23, 23 (valves) of the second pipes 20b, 20b are respectively open (S102) so as to supply a mixed gas at a predetermined flow rate (6 L/minute in this embodiment). The mixed gas is then supplied to the melting furnace 11 (S103 [gas supply step]) via the second pipes 20b, 20b. After that, in case it is detected (determined) that concentration of carbon monoxide in the melting furnace 11 measured by the carbon monoxide concentration meter 22 is equal to or below a predetermined concentration (10 ppm in this embodiment) and combustion of molten magnesium is absent (extinguished) in the melting furnace 11 (YES in S104 [molten metal combustion determining step]) the open/close valves 23 are closed (S105) so as to halt supply of a mixed gas to the melting furnace 11 via the second pipes 20b, 20b (S106 [gas supply step]).

The following is an example of experiment to explain this embodiment in detail:

### Experiment Example

An experiment was performed using a hot chamber die-cast machine 1 shown in FIG. 1 under experimental conditions similar to those in the first embodiment unless otherwise stated.

As shown in FIG. 4, similarly to the first embodiment, this experiment was performed for one-cycle operation time (five minutes) from start of charging of a magnesium ingot into the melting furnace 11 to completion of supply of 10-shot (time) quantity of molten magnesium to the molding machine 10.

After the experiment started, a smoke from the melting furnace 11 was visually checked when a magnesium ingot was charged. The carbon monoxide concentration in the melting furnace 11 was 24 ppm.

At that time, combustion of molten magnesium 12 was detected by the carbon monoxide concentration meter 22 (YES in S101) and the open/close valves 23, 23 of the second pipes 20b, 20b were open (S102) in accordance with the flow of FIG. 3. Then, a mixed gas composed of the FK gas and a diluting gas (FK gas concentration: 300 ppm) was supplied at a flow rate of 11 L/minute from the gas introduction device 21′ shown in FIG. 2(b) (S103).

After the supply for about one minute, it was determined that the smoke from the melting furnace 11 had disappeared with the carbon monoxide concentration dropped to 6 ppm. At that time, halt of combustion of the molten magnesium 12 was detected by the carbon monoxide concentration meter 22 (YES in S104) and the open/close valves 23 were closed (S105) with supply of a mixed gas to the melting furnace 11 via the second pipes 20b, 20b halted (S106).

Table 2 shows the comparison of experimental conditions and the resulting effects between a case where the gas supply device 2′ of this embodiment is used and a case where a related art gas supply device is used in the manufacturing process of magnesium die-cast products for one month (total 4560 cycles)

TABLE 2

| | | | | | Converted |
|---|---|---|---|---|---|
| | Gas supply (consumption) | | | | amount of CO₂ |
| | amount (kg) | | | Gas cost | discharge |
| | FK gas | CO₂ | Dry air | (yen/month) | (kg) |
| Related art | 2.0 | 467 | 310 | 155000 | 469 |
| example | | | | | |
| This | 1.3 | 301 | 200 | 101000 | 302 |
| embodiment | | | | | |

Note)
FK gas concentration in a mixed gas: 300 ppm; Diluting gas: Carbon dioxide/dry air → 50%/50% composition (volume ratio); Supply flow rate of a mixed gas: 6 L/minute (steady state), 11 L/minute (during combustion)

The gas supply device of this embodiment provides the following operation/working effects:

In case combustion of the molten magnesium 12 in the melting furnace 11 is generated, a mixed gas is supplied to the melting furnace 11 via the second pipes 20b, 20b effective for suppression of combustion to suppress the combustion by the carbon monoxide concentration meter 22 (molten metal combustion determination unit) in the melting furnace 11 of the hot chamber die-cast machine 1 and the gas introduction device 21 (gas supply unit) for starting/halting supply of a mixed gas to the melting furnace 11 via the second pipes 20b, 20b based on a concentration signal from the carbon monoxide concentration meter 22. On the other hand, in case combustion is not generated, supply of the mixed gas via the second pipes 20b, 20b may be halted to save the usage of the mixed gas. This makes it possible to reduce the total usage of a mixed gas while effectively suppressing combustion of molten magnesium thus reducing the running cost of a manufacturing facility for magnesium die-cast products as well as contributing to preservation of global environment.

While on/off control is made to start/halt supply of a mixed gas by way of the open/close valves 23 depending on the presence/absence of combustion of the molten magnesium 12 detected by using the carbon monoxide concentration meter 22 as a method for controlling start or halt of supply of a mixed gas to the melting furnace 11 in this embodiment, PID control may be made instead for changing the supply amount of a mixed gas to be supplied to the melting furnace 11 in accordance with the carbon monoxide concentration detected by the carbon monoxide concentration meter 22.

### Third Embodiment

The hot chamber die-cast machine 1 similar to that in the first embodiment is used in this embodiment. The third embodiment is the same as the first embodiment except that a gas supply device 2″ described below is used as a gas supply device. The type of the gas used is the same. Portions (members) common to those in the first embodiment are given the same or corresponding signs and the related description is omitted.

As shown in FIG. 2C, the gas supply device 2″ according to this embodiment includes a carbon monoxide concentration meter 22 (refer to FIG. 1B) as molten metal combustion determination unit for determining presence/absence of combustion of the molten magnesium 12 by detecting combustion of the molten magnesium 12, a gas introduction device 21″ for starting or halting supply of a mixed gas to the melting furnace 11 in accordance with a carbon monoxide concentration signal sent from the carbon monoxide concentration meter 22, and a piping system 20 for supplying a mixed gas to the melting furnace 11. The piping system 20 is composed of the first pipes 20a, 20a, the second pipes 20b, 20b, the third pipe 20c and collective piping 20d coupled to these pipes similar to the first embodiment. The collective piping 20d shown in FIG. 2C has a gas concentration meter 25 for measuring the concentration of the FK gas in a mixed gas passing through the piping 20d. On the pipe 4a connected to the fluoro-ketone gas bomb 4 shown in FIG. 2C has a flow rate regulating valve 26 for regulated the concentration of a mixed gas passing through the collective piping 20d.

The gas introduction device 21″ functions as a gas concentration regulating unit. As shown in FIG. 2C, the gas introduction device 21″ includes a gas mixing device 21a for mixing several types of gases, a constant flow rate device 21b′ for controlling the flow rate of a mixed gas supplied from the gas mixing device 21a to a predetermined flow rate value, a controller 21c″ for controlling the flow rate of the FK gas supplied from the fluoro-ketone gas bomb 4 to the gas mixing device 21a, and the flow rate regulating valve 26.

As shown in FIG. 2C, a concentration signal is inputted to the controller 21c″ from the carbon monoxide concentration meter 22 via communication lines 22a shown by broken lines and a concentration signal is inputted thereto via communication lines 25a shown by broken lines from the gas concentration meter 25, followed by processing in the controller 21c″. After the processing, a control signal is inputted to the flow rate regulating valve 26 arranged on the pipe 4a via communication lines 26a shown by a broken line. The flow rate regulating valve 26 starts or halts supply (mixing with a diluting gas) of the FK gas based on the control signal.

To be more precise, as shown in FIG. 3, in case it is detected (determined) that concentration of carbon monoxide in the melting furnace 11 measured by the carbon monoxide concentration meter 22 is equal to or above a predetermined concentration (15 ppm in this embodiment) and combustion of molten magnesium is present (generated) in the melting furnace 11 (YES in S101 [molten metal combustion determining step]), the flow rate regulating valve 26 (valve) provided to the pipe 4a is open so as to supply a cover gas at a predetermined flow rate (S102). The mixed gas containing a cover gas is then supplied to the melting furnace 11 (S103 [gas supply step]). After that, in case it is detected (determined) that concentration of carbon monoxide in the melting furnace 11 measured by the carbon monoxide concentration meter 22 is equal to or below a predetermined concentration (10 ppm in this embodiment) and combustion of molten magnesium is absent (extinguished) in the melting furnace 11 (YES in S104 [molten metal combustion determining step]), the flow rate regulating valve 26 is closed (S105) so as to halt supply of a cover gas to the melting furnace 11 (only a diluting gas is supplied) (S106 [gas supply step]).

The following is an example of experiment to explain this embodiment in detail:

### Experiment Example

An experiment was performed using a hot chamber die-cast machine 1 shown in FIG. 1 under experimental conditions similar to those in the first embodiment unless otherwise stated.

As shown in FIG. 4, same as the first embodiment, this experiment was performed for one-cycle operation time (five minutes) from start of charging of a magnesium ingot into the melting furnace 11 to completion of supply of 10-shot (time) quantity of molten magnesium to the molding machine 10.

After the experiment started, a smoke from the melting furnace 11 was visually checked when a magnesium ingot was charged. The carbon monoxide concentration in the melting furnace 11 was 23 ppm.

At that time, combustion of molten magnesium 12 was detected by the carbon monoxide concentration meter 22 (YES in S101) and the flow rate regulating valve 26 arranged on the pipe 4a connecting the mixing device 21a and the fluoro-ketone gas bomb 4 was open (S102) in accordance with the flow of FIG. 3. Then, a mixed gas composed of the FK gas and a diluting gas (FK gas concentration: 300 ppm) was supplied at a flow rate of 11 L/minute from the gas introduction device 21″ shown in FIG. 2C (S103).

After the supply for about one minute, it was determined that the smoke from the melting furnace 11 had disappeared with the carbon monoxide concentration dropped to 8 ppm. At that time, halt of combustion of the molten magnesium 12 was detected by the carbon monoxide concentration meter 22 (YES in S104) and the flow rate regulating valve 26 was closed (S105) and the FK gas concentration in the mixed gas supplied to the melting furnace 11 became 0 ppm (S106).

Table 3 shows the comparison of experimental conditions and the resulting effects between a case where the gas supply device 2″ of this embodiment is used and a case where a related art gas supply device is used in the manufacturing process of magnesium die-cast products for one month (total 4560 cycles).

TABLE 3

| | | | | | Converted |
|---|---|---|---|---|---|
| | Gas supply (consumption) | | | | amount of CO₂ |
| | amount (kg) | | | Gas cost | discharge |
| | FK gas | CO₂ | Dry air | (yen/month) | (kg) |
| Related art | 2.0 | 467 | 310 | 155000 | 469 |
| example | | | | | |
| This | 0.4 | 467 | 310 | 50000 | 467 |
| embodiment | | | | | |

Note)
FK gas concentration in a mixed gas: 300 ppm; Diluting gas: Carbon dioxide/dry air → 50%/50% composition (volume ratio); Supply flow rate of a mixed gas: 11 L/minute

The gas supply device of this embodiment provides the following operation/working effects:

In case combustion of the molten magnesium 12 in the melting furnace 11 is generated, the FK gas by the quantity (concentration) necessary for suppressing combustion is supplied to the melting furnace 11 to suppress the combustion by the carbon monoxide concentration meter 22 (molten metal combustion determination unit) in the melting furnace 11 of the hot chamber die-cast machine 1 and the gas introduction device 21 (gas supply unit) for setting the FK gas concentration in a mixed gas to a predetermined concentration (300 ppm) or 0 ppm based on a concentration signal from the carbon monoxide concentration meter 22. In case combustion is not generated, supply of the FK gas may be halted (the FK concentration in the mixed gas is set to 0 ppm) to save the usage of the FK gas. This makes it possible to reduce the total usage of the FK gas while effectively suppressing combustion of molten magnesium thus reducing the running cost of a manufacturing facility for magnesium die-cast products.

While on/off control is made to start/halt supply of a mixed gas by way of the flow rate regulating valve 26 depending on the presence/absence of combustion of the molten magnesium 12 detected by using the carbon monoxide concentration meter 22 as a method for controlling start or halt of supply of the FK gas to the melting furnace 11 in this embodiment, PID control may be made instead for changing the supply amount of the FK gas to be supplied to the melting furnace 11 by way of the flow rate regulating valve 26 in accordance with the carbon monoxide concentration detected by the carbon monoxide concentration meter 22.

### Fourth Embodiment

The hot chamber die-cast machine 1 and the gas supply device 2 similar to those in the first embodiment are used in this embodiment. The fourth embodiment is the same as the first embodiment. The type of the gas used is the same. Portions (members) common to those in the first embodiment are given the same or corresponding signs and the related description is omitted.

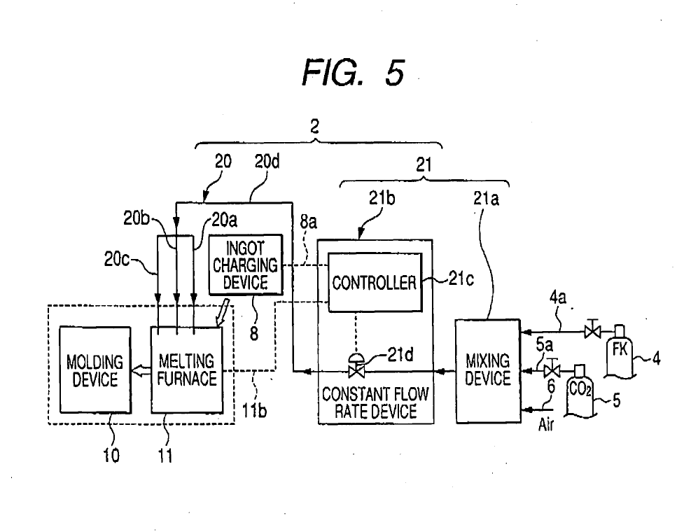

The gas supply device 2 according to this embodiment uses charge timing for charging a magnesium ingot melted into molten magnesium into the melting furnace 11 as molten metal combustion determination unit to determine the presence/absence of combustion of the molten metal by detecting or predicting combustion of the molten magnesium instead of the carbon monoxide concentration meter 22 used in the first embodiment. As shown in FIG. 5, the charge timing is transmitted as an electric signal to the controller 21c of the constant flow rate device 21b from the ingot charging device 8 via communication lines 8a shown by broken lines.

As shown in FIG. 5, in this embodiment, an operation signal including the charge timing is inputted from the ingot charging device 8 to the constant flow rate device 21b of the gas introduction device 21 in the gas supply device 2 via the communication lines 8a, followed by prediction (determination) of presence/absence of combustion in the controller 21c of the device 21b and on/off control processing to start or halt supply of a mixed gas. After the processing, a control signal is inputted to the flow rate regulating valve 21d arranged on the device 21b. The flow rate regulating valve 21d starts or halts supply of a mixed gas based on the control signal.

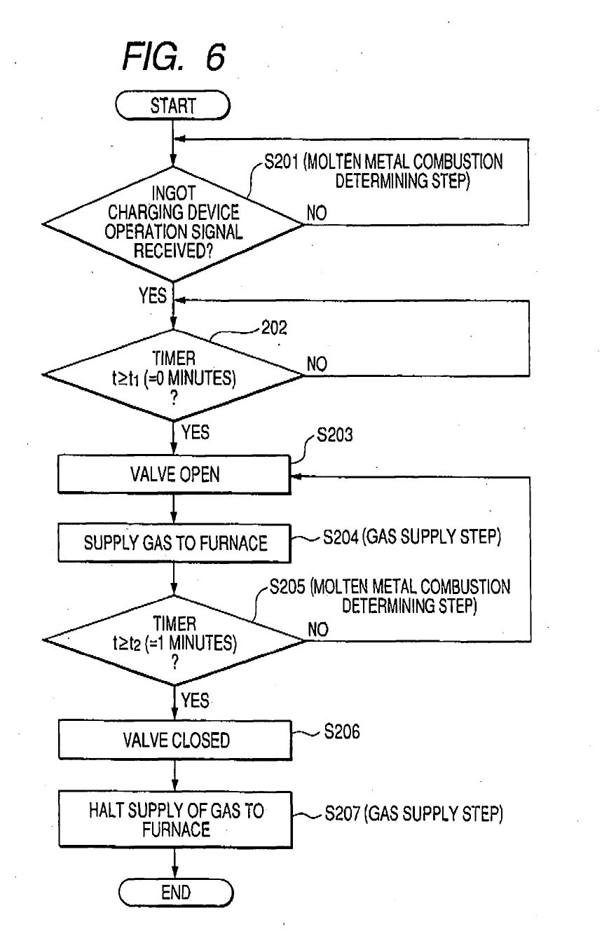

To be more precise, as shown in FIG. 6, an operation signal (electric signal) including charge timing to charge a magnesium ingot 7 from the ingot charging device 8 is received by the controller 21c of the constant flow rate device 21b. In case it is predicted (determined) that combustion of molten magnesium is present (generated) in the melting furnace 11 (YES in S201 [molten metal combustion determining step]), the flow rate regulating valve 21d (valve) of the constant flow rate device 21b is open so as to supply a mixed gas at a predetermined flow rate (11 L/minute in this embodiment) (S203) once a predetermined time t1 (0 minutes in this embodiment) has elapsed (S202). Then, the mixed gas is supplied to the melting furnace 11 (S204 [gas supply step]) After that, in case it is predicted (determined) that combustion of molten magnesium is absent (extinguished) in the melting furnace 11 (YES in S205 [molten metal combustion determining step]) once a predetermined time t2 (1 minute in this embodiment) has elapsed, the flow rate regulating valve 21d (valve) of the constant flow rate device 21b is closed (S206) so as to halt supply of a mixed gas to the melting furnace 11 (S207 [gas supply step]).

The following is an example of experiment to explain this embodiment in detail:

### Experiment Example

An experiment was performed using a hot chamber die-cast machine 1 shown in FIG. 1 under experimental conditions similar to those in the first embodiment unless otherwise stated.

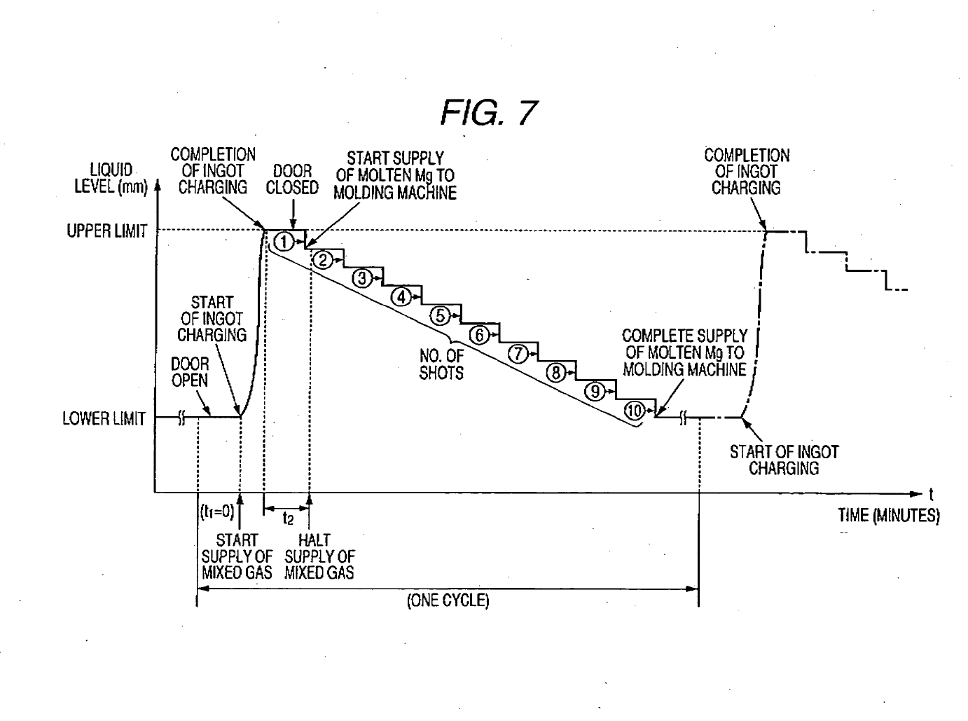

As shown in FIG. 7, this experiment was performed for one-cycle operation time (five minutes) from start of charging of a magnesium ingot into the melting furnace 11 to completion of supply of 10-shot (time) quantity of molten magnesium to the molding machine 10.

After the experiment started, a smoke from the melting furnace 11 was visually checked when a magnesium ingot was charged. The carbon monoxide concentration in the melting furnace 11 was 22 ppm.

At that time, in accordance with the flow of FIG. 6 an operation signal (electric signal) including charge timing to charge a magnesium ingot 7 from the ingot charging device 6 was received by the controller 21c of the constant flow rate device 21b, and it was predicted that combustion of molten magnesium was generated in the melting furnace 11 (YES in S201) and the flow rate regulating valve 21d of the constant flow rate device 21b was open (S203). From the gas introduction device 21 shown in FIG. 5, a mixed gas composed of the FX gas and a diluting gas (FK gas concentration: 300 ppm) was supplied at a flow rate of 11 L/minute (S204).

After the supply for about one minute, it was determined that the smoke from the melting furnace 11 had disappeared with the carbon monoxide concentration dropped to 7 ppm. After that, a predetermined time t2 (i.e., 1 minute in the embodiment) elapsed (S205) and the flow rate regulating valve 21d was closed (S206), followed by halt of supply of the mixed gas to the melting furnace 11 (S207).

Table 4 shows the comparison of experimental conditions and the resulting effects between a case where the gas supply device 2 of this embodiment is used and a case where a related art gas supply device is used in the manufacturing process of magnesium die-cast products for one month (total 4560 cycles).

TABLE 4

| | | | | | Converted |
|---|---|---|---|---|---|
| | Gas supply (consumption) | | | | amount of CO₂ |
| | amount (kg) | | | Gas cost | discharge |
| | FK gas | CO₂ | Dry air | (yen/month) | (kg) |
| Related art | 2.0 | 467 | 310 | 155000 | 469 |
| example | | | | | |
| This | 0.4 | 103 | 68 | 32000 | 103 |
| embodiment | | | | | |

Note)
FK gas concentration in a mixed gas: 300 ppm; Diluting gas: Carbon dioxide/dry air → 50%/50% composition (volume ratio); Supply flow rate of a mixed gas: 11 L/minute (steady state)

The gas supply device of this embodiment provides the following operation/working effects:

By using charge timing to charge the magnesium ingot 7 into the melting furnace 11 as molten metal combustion determination unit, it is possible to halt supply of a mixed gas to the melting furnace 11 in a steady state where absence of combustion of the molten magnesium 12 is predicted. It is also possible to supply a mixed gas in the time interval from start to completion of charging of the magnesium ingot 7 into the melting furnace 11 where presence of combustion of the molten magnesium 12 is predicted. This makes it possible to reduce the total usage of a mixed gas while effectively suppressing combustion of the molten magnesium 12 thus reducing the running cost of a manufacturing facility for magnesium die-cast products as well as contributing to preservation of global environment.

The above embodiment may be modified as follows:

Charge timing to charge the magnesium ingot 7 into the melting furnace 11 is used as molten metal combustion determination unit to determine the presence/absence of combustion of the molten magnesium 12 by predicting combustion of the molten magnesium 12 in this embodiment. Instead of the charge timing, open/close timing (refer to FIG. 7) for the open/close door (door) 14a of the melting furnace 11 opened/closed when the magnesium ingot 7 is charged into the melting furnace 11 may be used. Further, instead of the charge timing or the open/close timing, the supply timing (refer to FIG. 7) to supply molten magnesium from the melting furnace 11 to the molding machine 10 may be used.

An operation signal from the ingot charging device 8 is used as molten metal combustion determination unit for determining presence/absence of combustion of the molten magnesium 12 by detecting combustion of the molten magnesium 12 in this embodiment. The molten metal combustion determination unit may be the open/close timing or supply timing as an operation signal (operation signal from the melting furnace 11) inputted to the controller 21c of the constant flow rate device 21b from the melting furnace 11 via the communication lines 11b (refer to FIG. 5) shown by broken lines.

The molten metal combustion determination unit may be timing arbitrarily set irrespective of the operation signal from the ingot charging device 8 or, melting furnace 11.

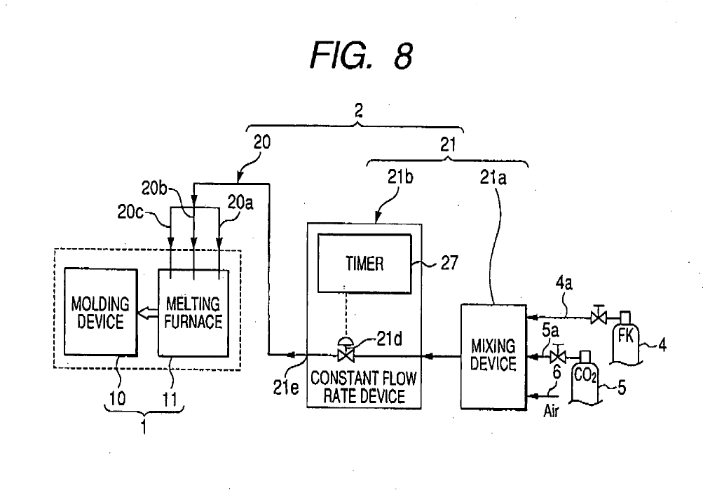

To be more precise, a timer 27 may be arranged in the constant flow rate device 21b of the gas supply device 2 of the first embodiment shown in FIG. 8. Such a device may be used in which the timer 27 controls the flow rate regulating valve 21d.

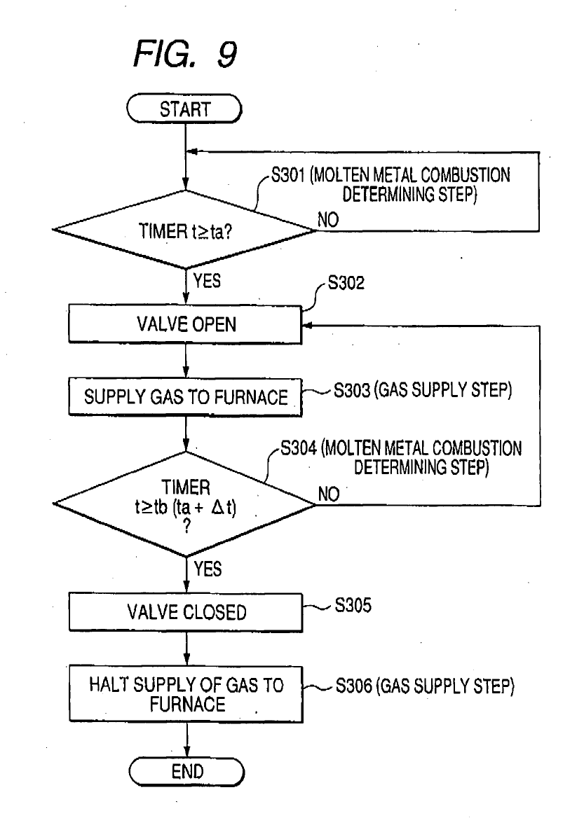

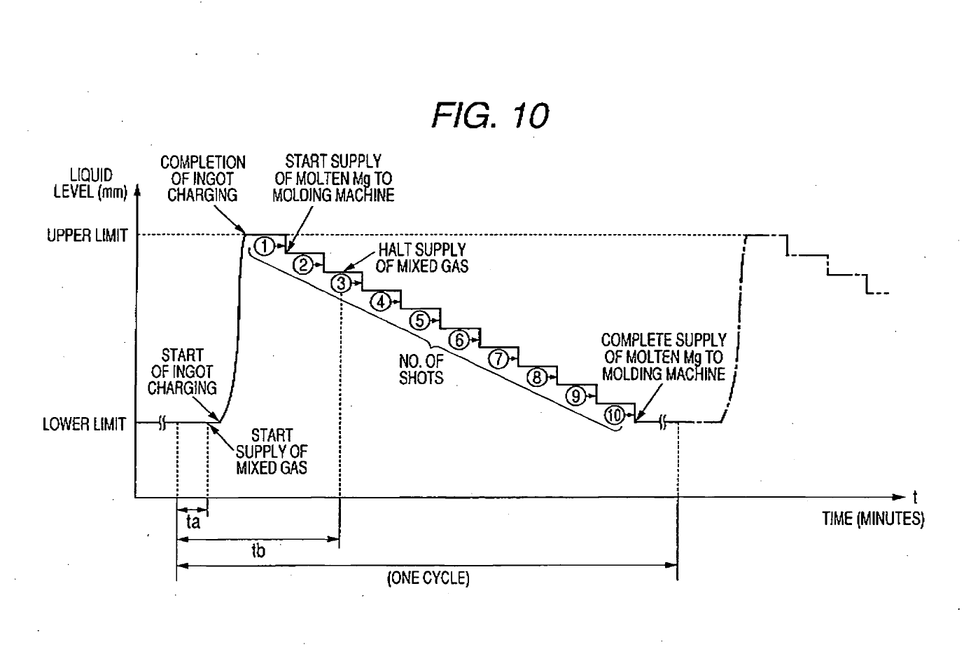

In the gas supply device 2, as shown in FIGS. 9 and 10, in case time-out of the timer 27 shown in FIG. 8 occurs with t≧ta (ta being a time arbitrarily set in minutes) and it is predicted (determined) that combustion of molten magnesium is present (generated) in the melting furnace 11 (YES in S301 [molten metal combustion determining step]), the flow rate regulating valve 21d (valve) of the constant flow rate device 21b is open (S302) so as to supply a mixed gas at a predetermined flow rate (11 L in this example) Then the mixed gas is supplied to the melting furnace 11 (5303 [gas supply step]). After that, in case time-out of the timer 27 shown in FIG. 8 occurs with t≧tb (tb being a time arbitrarily set in minutes) and it is predicted (determined) that combustion of molten magnesium is absent (extinguished) in the melting furnace 11 (YES in S304 [molten metal combustion determining step]), the flow rate regulating valve 21d (valve) of the constant flow rate device 21b is closed (S305). Supply of a mixed gas to the melting furnace is then halted (S306 [gas supply step]).

The molten metal combustion determination unit may be a state signal (for example, 1: Operating state; 0: Sleep state) determined in accordance with the state of the melting furnace 11 (operating state in which the melting furnace 11 is operating and non-operating sleep state rather than the above means (timing). The technical philosophy grasped from the foregoing embodiments and their variations is described below.

The combustion suppressing gas supply device for a molten metal according to any one of the first through third aspects, wherein the molten metal combustion determination unit is open/close timing for the open/close door of a melting furnace opened/closed when an ingot to be melted into a molten metal is charged into the melting furnace or supply timing to supply a molten metal to a molding machine to form a metal molded product from a melting furnace.

With this configuration, the same operation/working effects as those in the fourth embodiment are obtained.

The combustion suppressing gas supply device for a molten metal according to any one of the first through third aspects, wherein the molten metal combustion determination unit is arbitrarily set timing.

With this configuration, it is possible to predict combustion of a molten metal in a melting furnace with a simple method by using arbitrarily set timing as molten metal combustion determination unit.

The combustion suppressing gas supply device for a molten metal according to any one of the first through third aspects, wherein the molten metal combustion determination unit is a state signal determined in accordance with the state of the melting furnace.

With this configuration, it is possible to halt supply of a combustion suppressing gas such as a mixed gas to a melting furnace in case die-cast products are not manufactured and combustion of a molten metal is not likely to occur in a melting furnace and to supply a combustion suppressing gas in case die-cast products with possible combustion of a molten metal are manufactured.

What is claimed is:

1. A combustion suppressing gas supply device, the device comprising:
a gas supply unit that supplies a mixed gas composed of a mixture of a cover gas for suppressing combustion of a molten metal held in a melting furnace and a diluting gas for diluting the cover gas to the melting furnace; and
a molten metal combustion determination unit that determines presence/absence of combustion of the molten metal by detecting combustion of the molten metal or predicting combustion of the molten metal,
wherein the gas supply unit supplies the mixed gas to the melting furnace in case presence of combustion of the molten metal is determined and halts supply of the cover gas or the mixed gas to the melting furnace in case absence of combustion of the molten metal is determined.

2. The device according to claim 1, wherein
a plurality of supply areas for the mixed gas are defined in the melting furnace,
the gas supply unit starts or halts supply of the cover gas or the mixed gas to the melting furnace in a part of the gas supply areas.

3. The device according to claim 1, wherein
the gas supply unit includes a gas concentration regulating unit that regulates the concentration of the cover gas in the mixed gas, and
the gas concentration regulating unit mixes the cover gas with the diluting gas at a predetermined concentration and supplies the mixed gas to the melting furnace in case presence of combustion of the molten metal is determined and sets the concentration of the cover gas to 0 ppm and supplies the diluting gas to the melting furnace in case absence of combustion of the molten metal is determined.

4. The device according to claim 1, wherein
the molten metal combustion determination unit includes a carbon monoxide concentration meter for detecting the combustion of the molten metal by measuring the concentration of a carbon monoxide generated during the combustion.

5. The device according to claim 1, wherein
the molten metal combustion determination unit uses a charge timing with which an ingot to be melted into the molten metal is charged into the melting furnace.

6. A combustion suppressing gas supply method comprising:
determining presence/absence of combustion of a molten metal in a melting furnace by detecting combustion of the molten metal or predicting combustion of the molten metal;
supplying mixed gas, which is composed of a cover gas for suppressing combustion of the molten metal held in the melting furnace and a diluting gas for diluting the cover gas in case presence of combustion of the molten metal is determined; and
halting supply of the cover gas or the mixed gas to the melting furnace in case absence of combustion of the molten metal is determined.
